(19) United States
(12) Patent Application Publication
(10) Pub. No.: US 2011/0011286 A1
(43) Pub. Date: Jan. 20, 2011

(54) PRINTING OR EMBOSSING UNIT, AND WORKING CYLINDER FOR THE SAID UNIT

(75) Inventor: Georg STRASSER, Halden (CH)

Correspondence Address: BROWDY AND NEIMARK, P.L.L.C.;624 NINTH STREET, NW, SUITE 300, WASHINGTON, DC, 20001-5303, US

(73) Assignee: PANTEC GS SYSTEMS AG, Ruggell (LI)

(21) Appl. No.: 12/835,934

(22) Filed: Jul. 14, 2010

(30) Foreign Application Priority Data
Jul. 14, 2009 (EP) 09 165 465.7

(51) Int. Cl. B31F 1/07

(52) U.S. Cl. 101/23

(57) ABSTRACT

A printing or embossing unit has at least two cylinders (1, 2). Of the latter, one working cylinder (1) carries at least one printing or embossing stencil (14) on its circumference, in order to emboss or to print, with the aid of the said at least one printing or embossing stencil (14), a web (5) made from a flat material which is conveyed between the said working cylinder and a back-pressure cylinder (2). The embossing stencil (14) extends in each case only over part of the circumference of the working cylinder (1) and is held on the working cylinder (1) with the aid of a fastening device (12, 13, 15). The working cylinder (1) is provided in its interior with a heating device. The fastening device (12, 13, 15) has at least one clamping ring (15) which acts on the circumferential edge (16) of the printing or embossing stencil (14) and clamps against the working cylinder (1).

### TECHNICAL FIELD OF THE INVENTION

The invention relates to a printing or embossing unit having the features of the precharacterizing clause of Claim 1, and to a working cylinder having the features of the precharacterizing clause of Claim 9.

### PRIOR ART

A printing or embossing unit of this type according to the precharacterizing clause of Claim 1 is known from DE 196 12 314. The printing or embossing unit described there has two cylinders, of which one working cylinder carries at least one printing or embossing stencil on its circumference, in order to emboss or to print, with the aid of the said at least one printing or embossing stencil, a web made from a flat material which is conveyed between the said working cylinder and a back-pressure cylinder. The embossing stencil of DE 196 12 314 extends both in the axial direction of the working cylinder and in the circumferential direction of the working cylinder, in each case only over part of the working cylinder. It is held on the working cylinder with the aid of a fastening device which comprises two holding rings which are arranged to the left and the right of the embossing stencil and in which holes are provided in their longitudinal direction and threaded holes are provided which are aligned with the former, cylinder pins which are guided in the holes engaging into clamping faces of the embossing stencil which are cams which are arranged transversely with respect to the circumferential direction. On its circumference, the working cylinder has a heating device which is arranged between the said holding rings. The cylinder pins are held by threaded screws which are arranged in the threaded holes. The fastening device therefore has two clamping rings which act on the circumferential edge of the printing or embossing stencil and clamp against the working cylinder. The description of the adjustment by means of loosening and tightening of the threaded screws counter to springs provided between them and the cylinder pins shows the complexity of the adjustment. It also requires a pin/hole combination, in order to adjust the inserted embossing stencil at the correct provided position in the circumferential direction.

EP-A-1 393 904, for example, has disclosed another embossing device. Here, a plurality of stencils are fastened to a working cylinder offset in the axial direction and in the circumferential direction, by means of pins or screws and by means of wedges which act on oblique circumferential edges of the stencil. This type of fastening is not always reliable and, moreover, is relatively difficult to produce.

A simple fixing device of embossing stencils on a working cylinder is shown in U.S. 2005/081730, in which a heatable steel cylinder is surrounded by a slotted aluminium hollow cylinder which substantially encloses the said steel cylinder. Different embossing cylinders made from brass are pushed onto the said slotted aluminium hollow cylinder. As a result of the greater expansion of aluminium, the brass embossing cylinder is clamped on the steel working cylinder. An adjustment of the position of the embossing cylinder in the axial direction or in the circumferential direction is not provided.

### SUMMARY OF THE INVENTION

Proceeding from this prior art, the invention is therefore based on the object of finding a simpler fastening system for stencils which are divided in the circumferential direction, and this is effected by the characterizing features of Claim 1. According to the invention, only the clamping ring therefore need be pulled over the circumferential edge, two clamping rings which act on circumferential edges of the printing or embossing stencil which lie opposite one another expediently being provided.

It was necessary in the prior art to connect the respective stencil relatively rigidly to the working cylinder. In view of the fact that this cylinder is heated, however, and thermal expansions therefore result, it is more advantageous if, according to the invention, the fastening device has pins which penetrate holes of the respective printing or embossing stencil, preferably in each case one pin which is offset in the circumferential direction with respect to the other, at least one of the holes being larger in the circumferential direction than the cross section of the pin which penetrates the said hole.

If a “clamping ring” is mentioned in the context of this invention, it can be configured in a very wide variety of ways, for example also with a slot which makes a compliance possible and extends approximately parallel to the axis of the working cylinder or obliquely with respect thereto. It is preferred, however, if the thermal expansion itself is used for clamping, and it is advantageous for this purpose if at least one of the parts which are clamped around by the clamping ring, that is the working cylinder and/or the printing or embossing stencil, is composed of a material with a greater coefficient of thermal expansion, for example greater by at least 25%, than the material of the clamping ring.

This results in an automatic mechanism which applies stress to the parts only when the working cylinder or the printing or embossing unit is in operation and heated, whereas the stressing is triggered automatically in the other case.

This can be realized in such a way that the clamping ring is composed of a steel, in particular a tool steel, and in contrast the printing or embossing stencil is composed of a non-ferrous metal, in particular of brass, and/or in such a way that the clamping ring is composed of a tool steel, and in contrast the working cylinder is composed of chromium steel. It is to be mentioned here that the stated pairing of materials having different coefficients of thermal expansion can also be achieved with other materials, for example by the use of aluminium. However, the preferred chromium steel for the working cylinder is of greater strength and is therefore more suitable for the present purposes.

### BRIEF DESCRIPTION OF THE DRAWINGS

Further details of the invention result using the following description of one preferred exemplary embodiment which is shown diagrammatically in the drawing, in which:

FIG. 1 shows a diagrammatic view of a printing or embossing unit,

FIG. 2 shows an enlarged perspective view of the working cylinder and the back-pressure cylinder,

FIG. 3 shows a section through a printing or embossing stencil in contact with the surface of the working cylinder and fixed by two clamping rings,

FIG. 4 shows a perspective view of a printing or embossing stencil with fastening holes and pins, and

FIG. 5 shows an enlarged perspective view of the working cylinder and the back-pressure cylinder according to a further exemplary embodiment of the invention.

### DETAILED DESCRIPTION OF PREFERRED EXEMPLARY EMBODIMENTS OF THE INVENTION

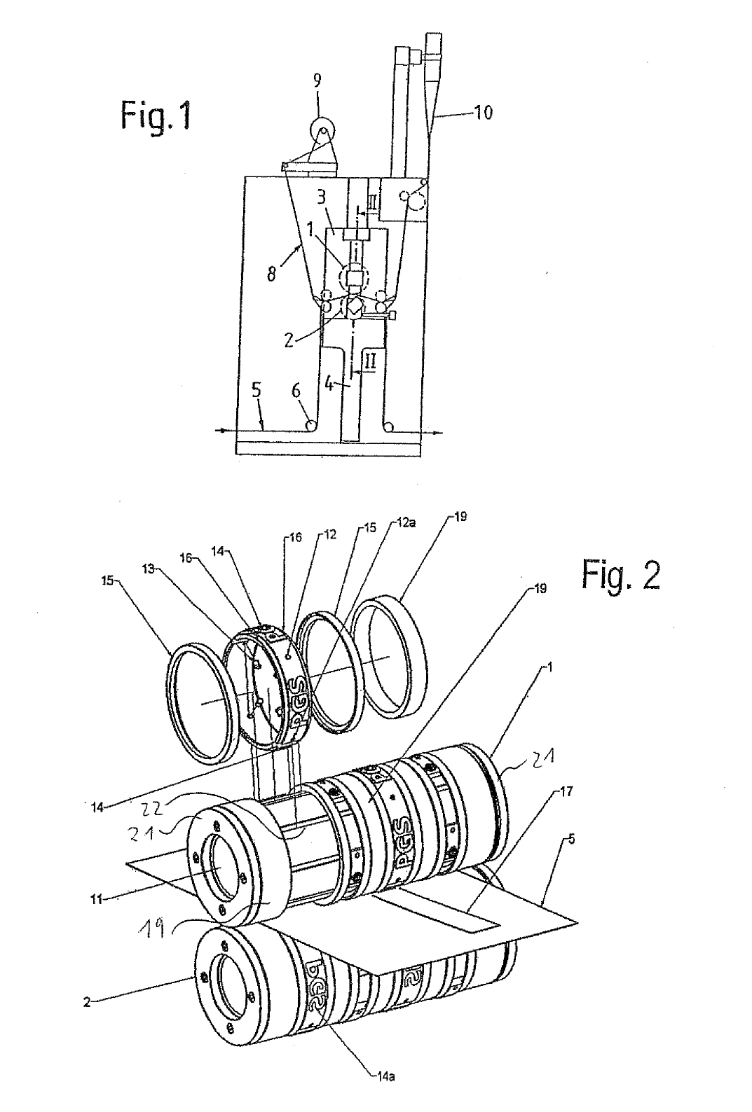

FIG. 1 diagrammatically shows a single printing or embossing unit having a working cylinder 1 and a back-pressure cylinder 2 behind a bearing plate 3 with a bearing block (indicated in FIG. 2) which is carried by the bearing plate 3. The bearing plate 3 rests on an approximately T-shaped bracket 4. In relation to FIG. 1, a web 5 to be printed or to be embossed is pulled off from the left from a supply reel (not shown), runs over a deflection roller 6 between the working cylinder 1 and the back-pressure cylinder 2, and is pulled off on the right-hand side over a further deflection roller 7 to form a receiving reel (not shown), as is known. It is clear that the web 5 is only one example and that, if corresponding conveying devices are present, individual sheets can optionally also be embossed or printed, the expression “web” of flat material also including sheets of this type.

The printing or the embossing takes place in a known way by means of a printing or embossing stencil (shown more clearly in FIG. 2) which is fastened to the working cylinder, via a printing or embossing film 8 which runs from a supply reel 9 in the same direction and carries, for example, a pattern to be printed on the web 5, a film to be transferred or the like, which pattern or the like is transferred hot to the web 5 during passage between the cylinders 1 and 2, whereupon the empty printing or embossing film 8 is pulled off upwards, sucked off, for example, into a collecting container 10 and is optionally comminuted in the process.

FIG. 2 shows the ratios of the working cylinder 1 and the back-pressure cylinder 2 in a perspective view. Here, the working cylinder is heated in a manner which is not shown here but is known per se, which preferably takes place in such a way as is described in claim 22 of German Laid-Open Specification No. 10 2005 054766, namely by a stationary heating cartridge which serves substantially as an axle and penetrates an opening 11 of the working cylinder 1.

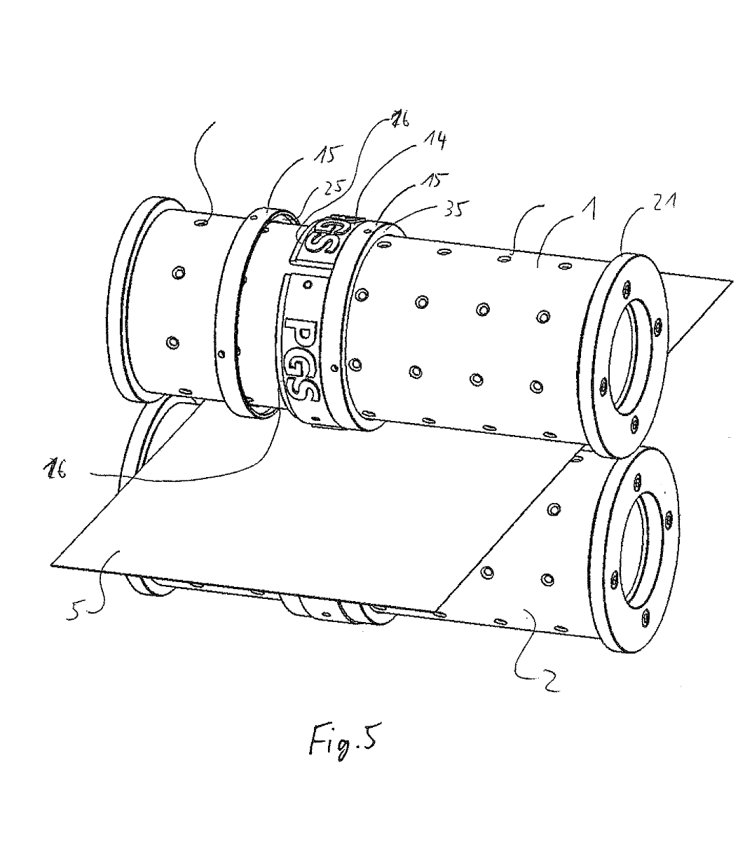

The working cylinder 1 has a row of elevated printing or embossing stencils 14 on its circumference, for example for printing labels, which printing or embossing stencils 14 are shown partially in FIG. 2 as separate parts. Each of these printing or embossing stencils 14 has the printing pattern (the letters PGS here) in an elevated manner, that is to say protruding from the stencil material. Since each of these stencils 14 extends only over part of the circumference of the working cylinder 1, for example with approximately 120 degrees over three or with approximately 180 degrees over two, it is necessary to fix them in their position relative to the working cylinder 1. For this purpose, two measures are preferably provided. Firstly, each of these printing or embossing stencils 14 which reach only over a part region of the circumference of the working cylinder 1 has fixing holes or positioning holes 12, into which fixing pins or, more precisely, positioning pins 13 engage. FIG. 4 shows this configuration on a larger scale. According to the latter, it can be seen that the positioning holes 12 are somewhat larger than the diameter of the pins 13. Only one of the positioning holes 12a is expediently of larger configuration, namely as a slot, in order for it to be possible for thermal expansions to be compensated for. This positioning-hole/positioning-pin arrangement serves only to fasten the stencil 14 in its circumferential direction in an axial groove 22. In contrast, it is fixed in its axial direction in each case by at least one clamping ring 15, advantageously by two clamping rings 15 which lie axially opposite one another as shown in FIG. 2, which expediently acts/act on a thinned edge piece 16 of the stencil. Secondly, it is clear that only a hook can also be provided instead of the fastening device 12, 13 or instead of the pin 13, whereas the pairing 12a, 13 ensures the movability as a consequence of thermal expansion along the circumference of the working cylinder 1.

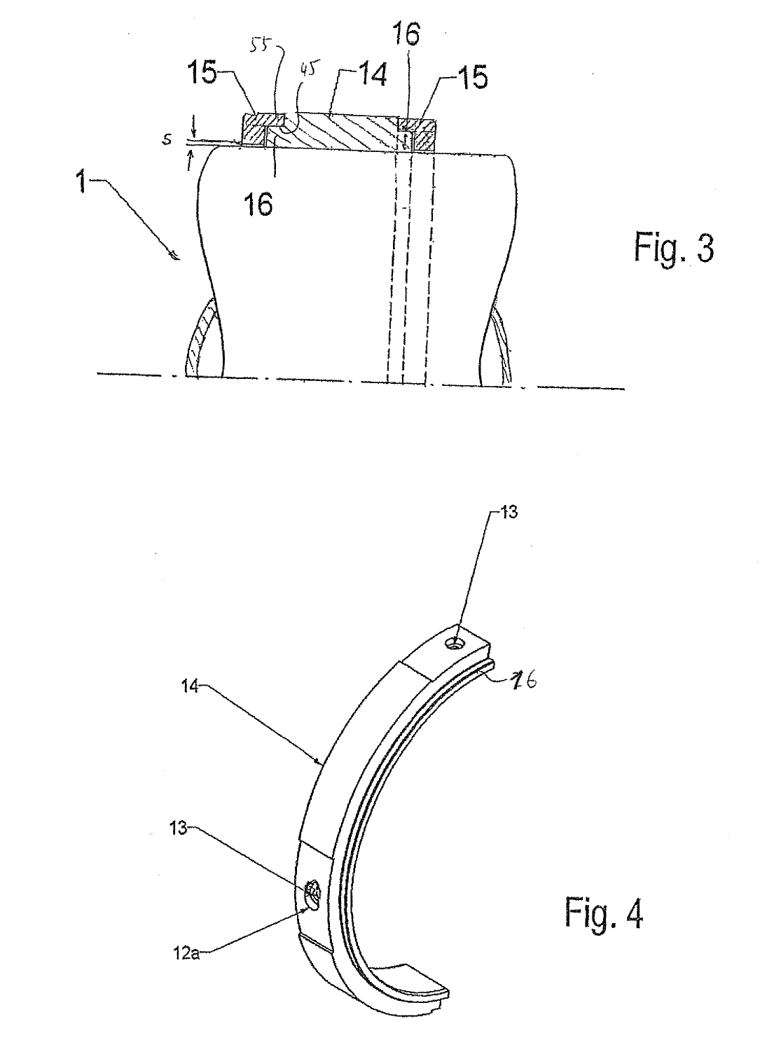

FIG. 3 shows the ratios on an enlarged scale. Whereas the stencil 14 bears against the surface of the working cylinder 1 and is positioned and fixed in the circumferential direction by means of the fastening arrangement 12, 13 which can be seen from FIG. 4, in each case one clamping ring 15 is pushed over its edges 16 on at least one side, preferably on both sides. This is facilitated particularly by the fact that, in the unheated state of the working cylinder 1, there is preferably a gap s between the internal diameter of the clamping ring and the external diameter of the working cylinder 1. There can also be a small gap (not shown here) between the external diameter of the respective edge 16 and the internal diameter of that section of the clamping ring 15 which acts on this edge 16.

On its side which faces the embossing stencil 14 during use on the working cylinder, each clamping ring 15 has a radially inwardly oriented recess 25. Where, on the side which faces away from the embossing stencil 14, the side wall 35 comes up to the external diameter of the working cylinder 1 apart from the gap s, there is a negative step with respect to the embossing stencil 14, which negative step is substantially complementary with respect to the lateral steps/thinner edges 16 of the embossing-stencil elements 14. Here, the inner cylinder shell surface which is directed opposite the working cylinder 1 is larger than the outer cylinder shell surface of the embossing-stencil elements 14; in other words, there is a step on one or both sides of the embossing-stencil elements 14, which step can be pushed under the holding-ring recesses 25.

The configuration of the L-shaped clamping rings 15 can also be defined differently, so that each clamping ring has a profile which has the entire height of the side wall 35, there being a protruding shoulder 55 at the greater diameter end. This shoulder 55 does not have to be of continuous configuration, as is shown in the drawings; it can also comprise tongues or angular sections of between, for example, 15 and 90 degrees with corresponding sections without a shoulder 55 of between, for example, 15 and 90 degrees.

“Automatic” fastening of the clamping rings 15 to the working cylinder 1 and/or to the stencil 14 can then be obtained by the coefficient of thermal expansion of the clamping rings being selected to be lower than that of the working cylinder 1 and/or of the stencil 14, for example at least 25% lower. If, for instance, the clamping ring 15 is composed of a steel, in particular a tool steel, and in contrast the printing or embossing stencil 14 is composed of a non-ferrous metal, in particular of brass, the latter will be expanded under the action of the heating of the working cylinder 1 and the heat transfer to the stencil 14 to a greater extent than the clamping ring, with the result that the latter clamps the edges 16 extremely firmly. Secondly, another result of the material pairing of the clamping ring 15 made from tool steel and the working cylinder 1 made from chromium steel is a more pronounced expansion of the working cylinder in the radial direction, as a result of which the gap s is reduced or, instead, the clamping ring 15 is seated fixedly on the surface of the working cylinder 1. Both measures, namely the utilization of the greater thermal expansion of the stencil 14 and the working cylinder 1 compared with that of the clamping ring 15, are expediently used together.

If the working cylinder 1 itself is heated, it expands to a greater extent than the clamping rings 15 as a result of the described material selection, with the result that the embossing-stencil elements 14 are pushed radially to the outside and the lateral steps 16 of the embossing-stencil elements 14 are clamped between the said outer shell face of the working cylinder 1 and the inner circumferential faces 45 of the clamping rings 15. As a result, the embossing-stencil elements 14 are fixed radially in their position in the longitudinal direction of the working cylinder 1. The axial positioning is fixed in advance with respect to the longitudinal groove 22 by the positioning pins 13 in the positioning holes 12, 12a.

Other materials with similar thermal expansion properties could also be used per se, for example a working cylinder 1 made from aluminium; however, it can be seen from FIG. 2 that a plurality of stencils 14 can be provided in the axial direction of the working cylinder 1, in order for it thus to be possible to obtain a plurality of labels next to one another by transfer of a medium 17, for instance a gold foil, in the region of the elevated letters (“PGS”) to a flat substrate or a web 5. Here, each circumferential row of stencils 14 is separated axially from the adjacent stencil 14 by a spacer ring 19. It is clear that the back-pressure cylinder 2 either has stencils 14a which are complementary with respect to the stencils 14 and therefore have depressions where the stencils 14 have elevations (for hot embossing), or the back-pressure cylinder 2 has a compliant surface (for printing or gold embossing), into which the elevations of the stencils 14 are pressed.

Essential aspects are the higher coefficient of thermal expansion of the working cylinder 1 with respect to the clamping ring 15 and the higher coefficient of thermal expansion of the embossing-stencil elements 14 with respect to the clamping ring 15, in order firstly to fix the clamping ring itself on the working cylinder 1 and secondly to fix the embossing-stencil elements 14 within the clamping ring. It is advantageous here that no screws at all have to be used for adjustment, but rather that the adjustment can happen automatically by, after a first flange 21 which is fastened on the working cylinder—and optionally one or more spacer rings 19, first of all a first clamping ring 15 being pushed against the last spacer ring 19, and the individual embossing-stencil elements or embossing-stencil sections 14 then being pushed under its recess, which individual embossing-stencil elements or embossing-stencil sections 14 are then covered on the other sides by a second clamping ring 15. In a simple embodiment, only one of the clamping rings 15 is configured with the projecting shoulder 55, whereas the other clamping ring 15 is pushed flatly against the embossing-stencil sections 14. This is then possibly followed by a further spacer ring 19 and/or further pairs of clamping ring 15/embossing-stencil sections 14/clamping ring. Compression springs are then inserted in a known manner between the last spacer ring 19 and the terminating flange 21, in particular guided in corresponding openings of the latter, in order to hold the ring system in a prestressed state before the heating of the working cylinder brings about the described stressing as a result of different material expansions.

It also becomes clear from the above text that, after the printing or embossing unit is switched off and after the working cylinder 1 has cooled down, the clamping rings 15 automatically release the edges of the stencils 14 and/or the working cylinder 1 again and can therefore be removed easily again.

FIG. 5 then shows an enlarged perspective view of the working cylinder 1 and the back-pressure cylinder 2 according to a further exemplary embodiment of the invention. Identical or similar features from both exemplary embodiments are provided in each case with the same reference numerals. A clamping ring 15/embossing-stencil elements 14/clamping ring 15 pair is shown here, a clamping ring 15 being pushed with its edge 55 over the thinned edge section 16 of the embossing-stencil elements 14, and the other clamping ring 15 being shown at a spacing from it. No spacer rings 19 are shown. The positioning pins 13 cannot be inserted here into axial grooves 22, but rather in a predefined pattern of setting positioning holes 23. Each embossing-stencil element 14 is therefore positioned in a predefined manner not only in the circumferential direction but also in an axial orientation. The clamping rings 15 therefore carry out the function directly and exclusively here of fixing the previously oriented embossing-stencil elements 14, which once again improves the changeover times for an apparatus of this type.

### LIST OF REFERENCE NUMERALS

1 Working cylinder

2 Back-pressure cylinder

3 Bearing plate

4 Bracket

5 Web to be embossed

6 Deflection roller

7 Deflection roller

8 Embossing film

10 Collecting container

11 Embossing film

12 Positioning hole

12a Slot

13 Positioning pin

14 Embossing-stencil element

14a Complementary stencil

15 Clamping ring

16 Thinned edge piece

17 Medium

18 Spacer ring

21 Flange

22 Axial groove

23 Setting positioning hole

25 Recess

35 Side wall

45 Inner circumferential faces

55 Protruding shoulder

s Gap

1-10. (canceled)

11. Printing or embossing unit, comprising
a working cylinder,
a back-pressure cylinder,
at least one printing or embossing stencil,
a fastening device for the at least one printing or embossing stencil, and
a heating device provided in the interior of the working cylinder,
wherein the working cylinder carries each stencil on its circumference, in order to emboss or to print, with the aid of said printing or embossing stencil a web made from a flat material which is conveyed between the said working cylinder and the back-pressure cylinder,
wherein each embossing stencil extends in each case only over part of the circumference of the working cylinder and is held on the working cylinder with the aid of the fastening device,
wherein the fastening device comprises at least one clamping ring which acts on the circumferential edge of the printing or embossing stencil and clamps against the working cylinder.

12. Printing or embossing unit according to claim 11, wherein the fastening device has two clamping rings which act on circumferential edges of the printing or embossing stencil which lie opposite one another.

13. Printing or embossing unit according to claim 11, wherein the fastening device has fixing pins which penetrate fixing holes of the respective printing or embossing stencil, wherein at least one of the fixing holes being larger in the circumferential direction than the cross section of the pin which penetrates the said hole.

14. Printing or embossing unit according to claim 13, wherein in each case one fixing pin is offset in the circumferential direction with respect to another.

15. Printing or embossing unit according to claim 11, wherein, in the unheated state of the working cylinder, the clamping ring has a gap with respect to the said working cylinder.

16. Printing or embossing unit according to claim 15, wherein. in the unheated state of the working cylinder, the clamping ring has a gap with respect to the stencil.

17. Printing or embossing unit according to claim 11, wherein at least one of the parts which are clamped around by the clamping ring from the group encompassing the working cylinder and the printing or embossing stencil, is composed of a material with a greater coefficient of thermal expansion than the material of the clamping ring.

18. Printing or embossing unit according to claim 17, wherein the coefficient of thermal expansion of the material with said greater coefficient of thermal expansion is greater by at least 25%.

19. Printing or embossing unit according to claim 17, wherein the clamping ring is composed of a steel and in contrast the printing or embossing stencil is composed of a non-ferrous metal.

20. Printing or embossing unit according to claim 19, wherein the clamping ring is composed of a tool steel.

21. Printing or embossing unit according to claim 19, wherein the printing or embossing stencil is composed of brass.

22. Printing or embossing unit according to claim 17, wherein the clamping ring is composed of a tool steel and in contrast the working cylinder is composed of chromium steel.

23. Printing or embossing unit according to claim 11, wherein at least two printing or embossing stencils are fastened to the working cylinder offset in the axial direction of the said working cylinder.

24. Working cylinder for a printing or embossing unit, having
at least one printing or embossing stencil,
a fastening device for the at least one printing or embossing stencil, and
a heating device provided in the interior of the working cylinder,
wherein each printing or embossing stencil extends only over part of the circumference of the working cylinder and is held on the working cylinder with the aid of the fastening device,
wherein the fastening device has at least one clamping ring which acts on the circumferential edge of the printing or embossing stencil and clamps against the working cylinder.

25. Working cylinder according to claim 24, wherein the fastening device comprises two clamping rings which act on circumferential edges of the printing or embossing stencil which lie opposite one another.

26. Working cylinder according to claim 24, wherein, in the unheated state of the working cylinder (1), the clamping ring has a gap with respect to the said working cylinder.

27. Working cylinder according to claim 24, wherein at least one of the parts which are clamped around by the clamping ring, that is to say the working cylinder and the printing or embossing stencil, is composed of a material with a greater coefficient of thermal expansion than the material of the clamping ring, the clamping ring being composed of a steel and in contrast the printing or embossing stencil being composed of a non-ferrous metal and in contrast the working cylinder being composed of chromium steel.
